(19) United States
(12) Patent Application Publication
(10) Pub. No.: US 2026/0311156 A1
(43) Pub. Date: Oct. 8, 2026

(54) AUTOMATED WEIGHT SENSOR DRIFT DETECTION AND CORRECTION

(71) Applicant: Maplebear Inc., San Francisco, CA (US)

(72) Inventors: Kaushik Gopal, Oakland, CA (US); Christopher Paiano, Winter Springs, FL (US); Hilary Dalldorf, New York, NY (US); Yilin Huang, Shanghai (CN)

(21) Appl. No.: 19/340,266

(22) Filed: Sep. 25, 2025

Related U.S. Application Data
(63) Continuation of application No. PCT/CN2025/087773, filed on Apr. 8, 2025.

(51) Int. Cl. G06Q 20/20; G01G 19/414; G01G 23/01

(52) U.S. Cl. CPC G06Q 20/208; G01G 19/4144; G01G 23/01

(57) ABSTRACT

An online system that detects and addresses weight sensor drift is provided. The online system determines that a session of using a smart cart has ended and that the smart cart is empty. The online system captures a weight measurement from weight sensors at the smart cart and stores the weight measurement with historical weight measurements captured for the smart cart. The online system calculates a drift score based on the historical weight measurements and compares the drift score to a threshold value. In response to the drift score exceeding a threshold value, the online system causes the weight sensors to recalibrate by resetting their zero values to correspond to a weight measurement of the empty smart cart.

### CROSS REFERENCE TO RELATED APPLICATIONS

This application is a bypass continuation of international Patent Application Serial No. PCT/CN2025/087773, filed Apr. 8, 2025, which is incorporated by reference herein in its entirety.

### BACKGROUND

Weight sensors, typically found in industry-standard equipment employed in numerous fields, have a chronic problem of becoming uncalibrated (e.g., drifting) over time. This drift is caused by a change in the baseline weight measurement that the weight sensor uses as a point of comparison when capturing measurements of the load on the weight measurement. This degradation in performance stems from environmental factors, repetitive use, mechanical shock, and time-based wear and tear. When this baseline drifts, the weight sensor generates inaccurate measurements, which can cause errors in the broader systems of which the weight sensors are a part.

There are certain existing techniques for correcting this drift in weight sensors that can be used in certain contexts. For example, some devices using weight sensors provide a “tear” function that allows a user to reset the baseline of the weight sensor. However, this solution cannot be used to address weight sensor drift in many devices. For example, smart cart systems cannot address weight sensor drift through a tear function because smart cart systems operate in dynamic environments. Smart cart systems are generally mobile and in high use and thus additional care is required to ensure that the system is properly situated (e.g., not moving and without any items in the storage area) when the weight sensor is calibrated. Thus, many devices with weight sensors remain improperly calibrated during their use.

### SUMMARY

In accordance with one or more aspects of the disclosure, a smart cart system that can detect and address sensor drift is described. The smart cart system determines that a user session using a smart cart (also referred to as a “smart shopping cart” or “shopping cart” herein) has ended and that the smart cart is empty. The smart cart system captures a weight measurement from the smart cart and stores the weight measurement in association with the smart cart in a data set. The data set includes weight measurements captured after user sessions with the smart cart ended. The smart cart system determines a drift score based on the weight measurements associated with the smart cart and determines that the outputs of a weight sensor that captured the weight measurements have drifted based on the drift score exceeding a threshold value. In response to detecting drift of the weight sensor outputs, the smart cart system causes the weight sensor to recalibrate such that its zero value corresponds to the empty smart cart.

Therefore, the described smart cart system improves on the technical field of automated sensor technologies by detecting and remedying weight sensor drift. Specifically, by automatically detecting and recalibrating drift in weight sensors, the described smart cart systems allow for the calibration of weight sensors in contexts where conventional techniques (e.g., a tear function) are unavailable. Additionally, by taking measurements at the end of multiple user sessions with the smart cart, the described smart cart systems calibrate based on measurements captured when the smart cart system is most likely to be stable, both in the short term (e.g., because the cart is not moving or has no items in it) and in the longer term (e.g., because the drift in the weight sensor has stabilized).

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates example graphs of weight measurements from a smart cart, in accordance with one or more embodiments.

FIG. 4 is a flowchart of an example process for detecting drift in historical shopping data, in accordance with one or more embodiments.

### DETAILED DESCRIPTION

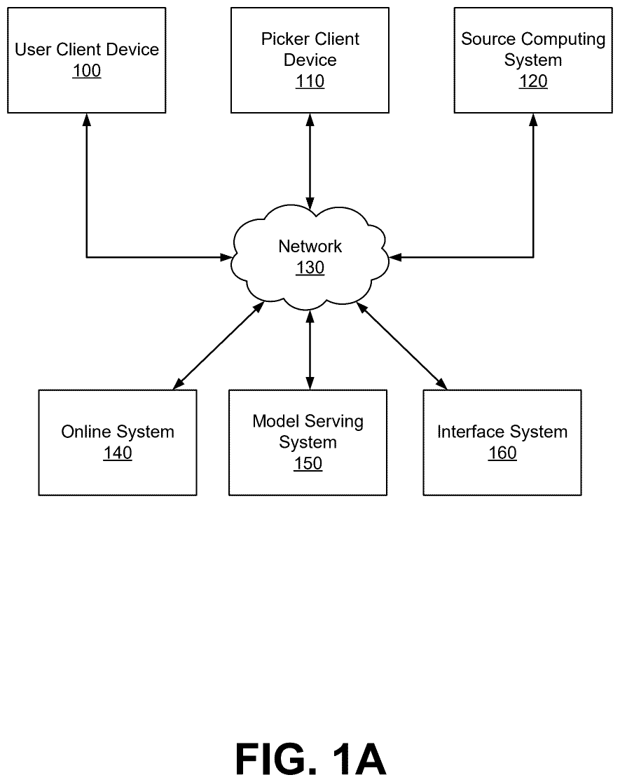

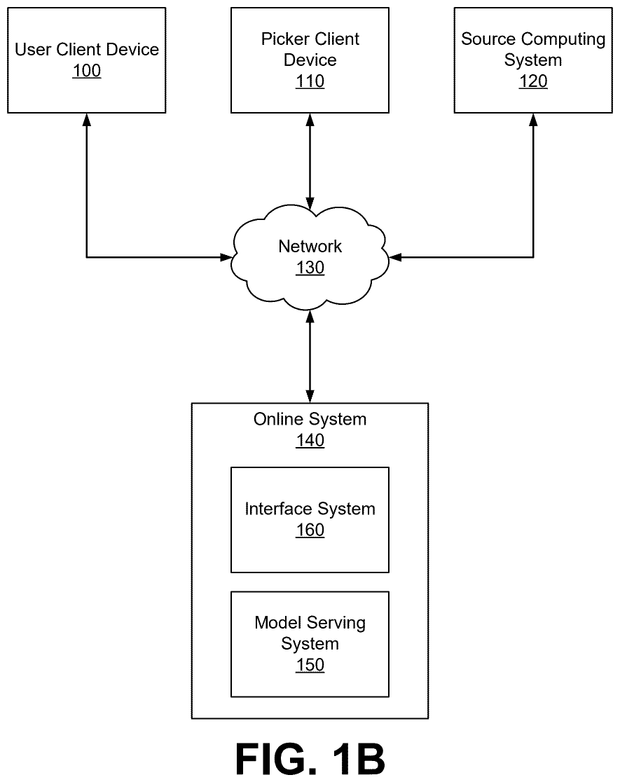

FIG. 1A illustrates an example system environment for an online system 140, in accordance with one or more embodiments. The system environment illustrated in FIG. 1A includes a user client device 100, a picker client device 110, a source computing system 120, a network 130, an online system 140. a model serving system 150 and/or an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

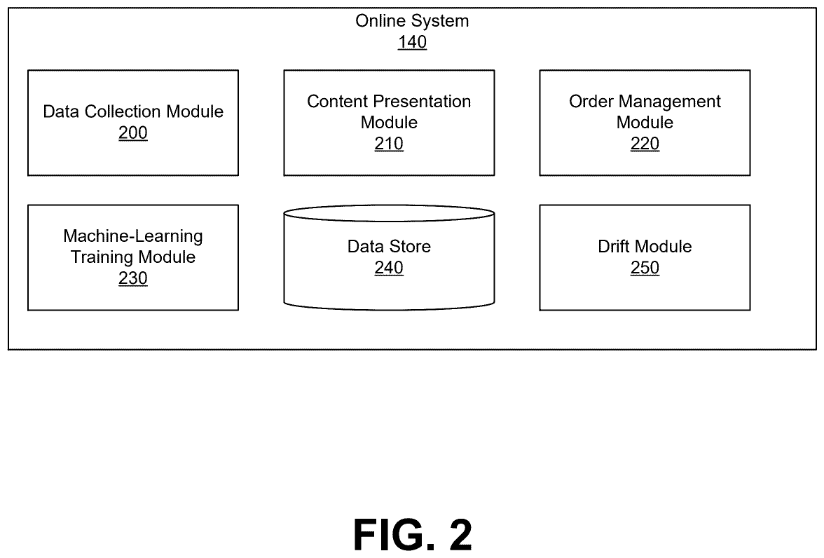

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In some examples, as illustrated in the example system environment in FIG. 1B, the model serving system 150 or the interface system 160 may be managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, and a drift module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 may also collect item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 may also collect picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 may collect order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 may select which items to present to a user while the user is placing an order. The content presentation module 210 may generate and transmit an ordering interface for the user to order items. The content presentation module 210 may populate the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 may score items based on a search query received from the user client device 100. A search query is free text for a word or set of words that indicate items of interest to the user. The content presentation module 210 may score items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 may score items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 may receive orders from a user client device 100 and offer the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 may determine when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data and may use databases to organize the stored data.

The drift module 250 may detect whether a smart cart is in a user session. A smart cart is part of a user session when a picker (or other individual) uses the smart cart to move items within a grocery store (or other facility). The drift module 250 may receive sensor data from one or more sensors attached to or spaced around the smart cart. The sensors may include weight sensors, accelerometers, cameras, global positioning systems (GPSs), and any other sensor capable of detecting items in the smart cart or movement of the smart cart. The drift module 250 may determine whether the smart cart is holding items in its basket and/or moving within a grocery store or other facility, thus indicating the smart cart is being used for a user session. In some embodiments, the drift module 250 may determine that the smart cart is being used in a user session based on receiving an identifier of the smart cart from a picker client device 110 or an indication from a physical button or switch on the smart cart. In another example, a picker may need to unlock the smart cart to use it, and the lock may include sensors that communicate a locked status and unlocked status to the drift module 250.

The drift module 250 may determine when the user session has ended based on occurrence of a concluding interaction determined based on sensor data. A concluding interaction is an event or interaction that indicates a conclusion of the user session with the smart cart. For example, the drift module 250 may determine that the user session has ended based on one of the following concluding interactions occurring: the smart cart being located at an exit of the grocery store, the smart cart not moving for at least a threshold amount of time, the weight associated with the basket depletes within a threshold amount of time, the smart cart is locked, or the like. In another example, the drift module 250 determines that the user session has ended based on receiving an indication from a picker client device 110.

The drift module 250 may transmit a prompt to the picker to remove items from the smart cart. The drift module 250 transmits the prompt in response to determining that the user session has ended. In some embodiments, the drift module 250 may check whether the smart cart has items in it using image data of the smart cart or weight data of the shopping case. For example, the basket of the smart cart may include a plurality of weight sensors on an inner bottom surface that are configured to capture weight measurements representing how much weight is in the basket of the smart cart. The drift module 250 may send the prompt upon determining that the basket of the smart cart is holding at least a threshold weight. The threshold weight may correspond to the item with the lowest weight that the picker added to the smart cart during the user session, which the drift module 250 may determine using image data of the smart cart and item data associated with items at the grocery store or other facility.

The drift module 250 may retrieve a weight measurement from one or more weight sensors in the smart cart while the smart cart is empty. The smart cart may include multiple weight sensors at the bottom of its basket, at a rack under the basket, and/or the child seat basket, which some pickers may place items in. The drift module 250 stores the weight measurement as weight sensor log data in the data store 240. For example, the drift module 250 may store the weight measurement in association with an identifier of the smart cart, the time period and date of the user session, items purchased in relation to the user session, a picker who used the smart cart during the user session, an indication that the weight measurement was captured after conclusion of a user session (e.g., is a concluding measurement), and the like. In some embodiments, the drift module 250 may retrieve the weight measurement in response to determining that a set of initial conditions at the smart cart have been met. The initial conditions may include the smart cart being empty, the smart cart not moving, the outputs of the weight sensor being stable which is further described below, and the like.

The drift module 250 may determine whether the weight sensor(s) at the smart cart is experiencing drift. The drift module 250 retrieves weight sensor log data associated with the smart cart in the data store 240. In some embodiments, the drift module 250 may only retrieve weight sensor log data captured since the weight sensor(s) was last zeroed (e.g., reset such that the weight sensor(s) output a measure of zero when the smart cart is empty). The drift module 250 determines whether the weight sensor(s) have experienced significant drift based on the weight sensor log data. In some embodiments, the drift module 250 may calculate a drift score based on a most recent concluding measurement and the weight sensor log data. The drift score may represent a change in output of the weight sensor over time since a last occurrence of recalibration of the weight sensor. The drift module 250 may determine that the output of the weight sensor(s) has significantly drifted based on the drift score exceeding a drift threshold. The drift threshold may be a value set by an external operator or a manufacturer associated with the weight sensor(s). In some embodiments, the drift module 250 may apply a statistical interquartile range (IQR) analysis or another outlier removing analysis to the weight sensor log data and determine that the weight sensor(s) experienced significant drift in response to the difference in an upper median and lower median of the weight measurements being greater than a range threshold.

The drift module 250 may determine whether the weight sensor(s) are outputting stable outputs. In some embodiments, the drift module 250 may calculate a range of weight measurements and determine that the weight sensor(s) are not stable in response to the range being wider than a threshold amount. The drift module 250 may calculate the range on a set of weight measurements captured over a short time period (e.g., 1, second, 10 seconds, etc.) or between a most recent previous concluding measurement and the concluding measurement. The drift module 250 may send an indication to an operator or smart cart servicing entity in response to determining that the outputs are not stable.

The drift module 250 may recalibrate the weight sensor(s) of the smart cart. Recalibrating the weight sensor may include resetting a starting output value for the weight sensor to read as showing zero weight detected (e.g., zero-setting the weight sensor). The drift module 250 may do so in response to determining that the weight sensor(s) experienced significant drift. In some embodiments, the drift module 250 may also confirm that the weight sensor(s) are stable (e.g., outputting stable weight measurements) before recalibrating the weight sensors(s). The drift module 250 may recalibrate the weight sensors by transmitting instructions that cause the weight sensors to calibrate based on the empty smart cart, such that the weight sensor(s) output the current weight of the smart cart as zero pounds.

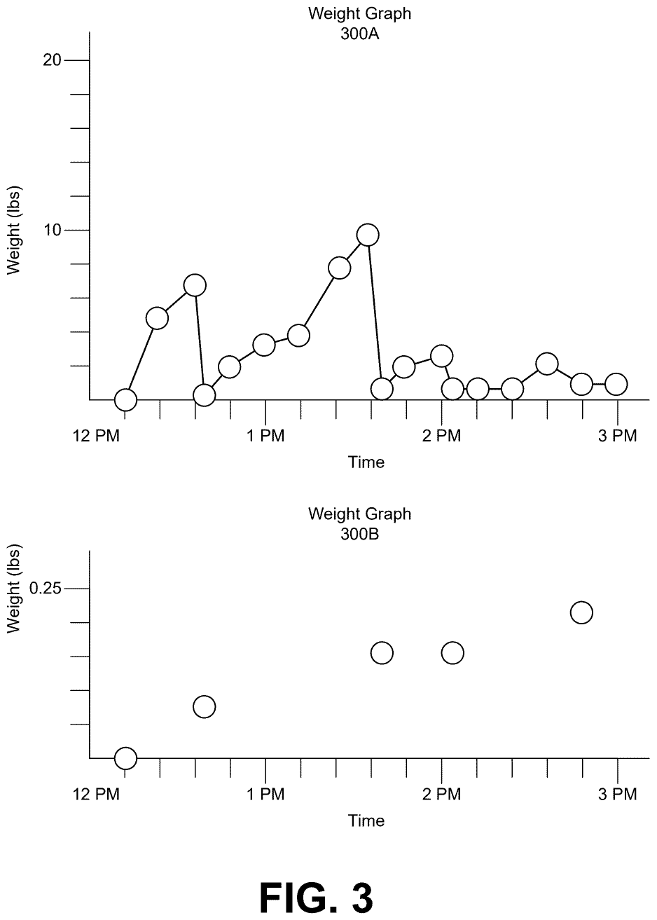

FIG. 3 illustrates example graphs 300A, 300B of weight measurements from a smart cart, in accordance with one or more embodiments. Each graph 300 covers a time period from 12 PM to 3 PM. In this example, the weight sensor(s) of the smart cart automatically captures weight measurements every 15 minutes. In some embodiments, the weight sensors may periodically capture weight measurements at other increments or in response to receiving a request for a weight measurement from the online system 140. For example, the online system 140 may request a weight measurement upon determining that image data depicts an empty smart cart, that a picker has begun a user session with the smart cart, and the like.

Weight graph 300A depicts all weight measurements captured over the time period. The data points thus include weight measurements that were captured when the smart cart was holding items for an order. Weight graph 300B depicts weight measurements captured while the smart cart is empty, as determined by the online system 140. As shown in weight graph 300B, the weight measurements drift upward from zero pounds to about 0.21 pounds. The smart cart was empty during these weight measurements, so weight graph 300B thus depicts drift in the outputs of the weight sensor(s). If the online system 140 determines that this drift is significant, the online system 140 may recalibrate the weight sensor(s).

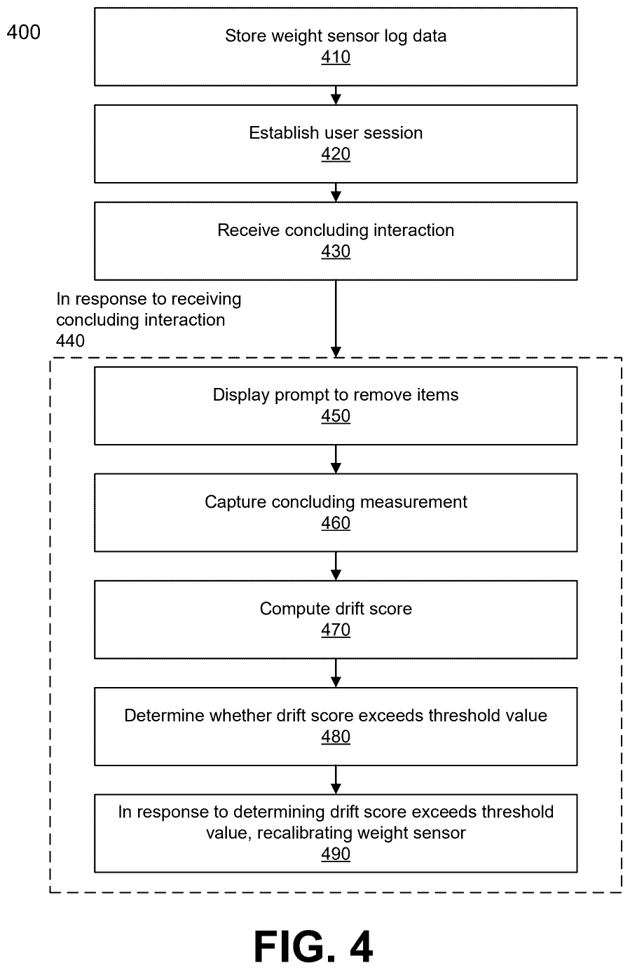

FIG. 4 is a flowchart of an example process 400 for detecting drift in weight sensor log data, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 stores 410 weight sensor log data describing weight measurements captured at the conclusion of user sessions with a smart cart. The online system 140 establishes 420 a user session upon receiving an interaction via the smart cart indicative of the user session, such as the smart cart moving, one or more items being placed into the smart cart, receiving an indication of a user session from a user client device 100, etc. The online system 100 detects an end of the user session. In some embodiments, the online system 100 receives 430 a concluding interaction with the smart cart and determines that the user session has ended based on the receipt. Examples of concluding interactions include selecting one or more interactive elements presented at a user interface at the smart cart or a user client device 100, detecting that the smart cart is not holding any items, detecting that the smart cart has been returned to a cart holding area, etc.

In response to receiving the concluding interaction 440, the online system 140 displays 450 a prompt at a user interface of the smart cart (or a picker client device 110 or user client device 100, in some embodiments) indicating to remove items from the smart cart. The online system 140 may receive sensor data from one or more sensors attached to or spaced around the smart cart and use the sensor data to determine if the smart cart is empty. In some embodiments, upon determining that the smart cart still includes items, the online system 140 resends the prompt or sends an indication to an operator at a grocery store that the smart cart is not empty. The online system 140 captures 460 a concluding measurement from a weight sensor(s) at the smart cart and stores the concluding measurement as weight sensor log data associated with the smart cart in the data store 240. In some embodiments, in response to determining that a user did not remove the items from the smart cart, the online system 140 waits to retrieve the concluding measurement from the weight sensor until new sensor data indicates that the items have been removed from the smart cart.

The online system 140 determines whether the outputs of the weight sensor(s) are drifting. The online system 140 may do so in response to a request from an operator at the grocery store, at periodic increments, after a threshold number of user sessions at the smart cart have ended or based on another triggering condition. The online system 140 retrieves weight sensor log data associated with the smart cart. The online system 140 computes 470 a drift score based on the weight sensor log data and the concluding measurement. The drift score may represent a range of the weight sensor log data and concluding measurement or may be determined using an IQR analysis (or another drift analysis) of the weight measurements. For example, the online system 140 may filter outliers from the weight measurements and use a range of the remaining weight measurements as the drift score. The online system 100 determines 480 whether the drift score exceeds a threshold value, and, in response to the drift score exceeding the threshold value, determines that outputs of the weight sensor have drifted.

In response to the drift score exceeding the threshold value (e.g., detecting drift), the online system 140 recalibrates 490 the weight sensor(s) of the smart cart. In some embodiments, the online system 140 determines that the outputs of the weight sensor(s) are stable before recalibrating the weight sensor(s). For instance, the online system 140 may calculate a variance in weight sensor log data captured since a most recent previous calibration and determine that the outputs are stable in response to the variance being below a stability threshold. In some embodiments, in response to determining that the outputs of the weight sensor(s) are not stable, the online system 140 sends a notification to an operator at the grocery store that the weight sensor(s) need servicing and/or prevents the cart from moving (e.g., by locking its wheels) such that pickers cannot use the smart cart for user sessions.

In some embodiments, the online system 140 may check that each of a set of initial conditions of the smart cart meet a respective threshold before capturing 460 the concluding measurement from the weight sensor(s). For example, the online system 140 may determine whether the weight sensor(s) is detecting less than a threshold weight, the smart cart is empty, the smart cart is not moving, that the outputs of the weight sensor(s) are stable, etc. In some embodiments, the online system 140 checks a set of conditions before recalibrating the weight sensor(s). For example, the online system 140 may determine whether the weight sensor(s) is detecting less than a threshold weight, the smart cart is empty, the smart cart is not moving, that the outputs of the weight sensor(s) are stable, that the determined drift is more than an acceptable threshold. The online system 140 may use sensor data captured at or around the smart cart to determine whether the initial conditions are met. For example, the online system 140 may assess image data captured by a camera on the smart cart and/or image data captured by cameras located in an environment around the smart cart to determine whether the smart cart is empty.

Though described in relation to weight sensors, the example process 400 may be used to detect drift in other types of sensor data. For example, upon determining, based on image data, that a smart cart is not moving, the online system 140 may receive outputs from an accelerometer on the smart cart. The online system 140 may determine whether the outputs from the accelerometer are indicative of drift and recalibrate the accelerometer while the smart cart is not moving. Further, although the example process 400 is described in relation to shopping in a grocery store, the example process 400 may be used in other scenarios. For example, the example process 400 may be used to recalibrate weight sensors on cargo trucks, medical scales, etc.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed by a computer system comprising a processor and a computer-readable medium, comprising:
storing weight sensor log data for a smart cart, wherein the weight sensor log data describes a plurality of concluding weight sensor measurements that describe weight sensor measurements captured at ends of user sessions for users at the smart cart;
establishing a user session for a user at the smart cart;
receiving a concluding interaction through a user interface of the smart cart, wherein the concluding interaction is an interaction that indicates a conclusion of the user session with the smart cart; and
in response to receiving the concluding interaction:
displaying a prompt through the user interface for the user to remove items from the smart cart;
capturing a concluding measurement from the weight sensor at the smart cart;
computing a drift score that represents a change of concluding measurements captured by the weight sensor over time, wherein the computed drift score is based on the concluding measurement and the weight sensor log data;
determining whether the drift score exceeds a threshold value; and
in response to determining that the drift score exceeds the threshold value, recalibrating the weight sensor.

2. The method of claim 1, further comprising:
filtering the weight sensor log data based on an interquartile range statistical method; and
computing the drift score based on the filtered weight sensor log data.

3. The method of claim 2, further comprising:
checking each of a set of initial conditions of the smart cart; and
in response to each of the set of initial conditions meeting a respective threshold, capturing the concluding measurement from the weight sensor at the smart cart.

4. The method of claim 3, wherein the initial conditions include one or more of stability of the smart cart, motion of the smart cart, and a maximum acceptable drift detected for the weight sensor.

5. The method of claim 4, wherein the initial conditions include whether the smart cart is empty, the method further comprising:
receiving image data from one or more cameras at the smart cart; and
determining, based on the image data, that the smart cart is empty.

6. The method of claim 1, wherein the smart cart includes a set of weight sensors placed at the smart cart.

7. The method of claim 1, further comprising:
receiving image data from one or more cameras at the smart cart;
determining, based on the image data, that the user did not remove one or more items from the smart cart; and
in response to determining that the user did not remove the one or more items from the smart cart, waiting to capture the concluding measurement until new image data indicates that the one or more items have been removed from the smart cart.

8. The method of claim 1, further comprising:
comparing the concluding measurement to a most recent previous concluding measurement in the weight sensor log data; and
in response to determining that drift of the weight sensor is not stable based on the comparing, transmitting an indication to service the weight sensor to a client device associated with an operator.

9. The method of claim 1, further comprising:
comparing the concluding measurement to a most recent previous concluding measurement in the weight sensor log data;
wherein the weight sensor is recalibrated further responsive to determining that drift of the weight sensor is stable.

10. A non-transitory computer-readable storage medium storing instructions, that when executed by a processor, cause the processor to perform steps comprising:
storing weight sensor log data for a smart cart, wherein the weight sensor log data describes a plurality of concluding weight sensor measurements that describe weight sensor measurements captured at ends of user sessions for users at the smart cart;
establishing a user session for a user at the smart cart;
receiving a concluding interaction through a user interface of the smart cart, wherein the concluding interaction is an interaction that indicates a conclusion of the user session with the smart cart; and
in response to receiving the concluding interaction:
displaying a prompt through the user interface for the user to remove items from the smart cart;
capturing a concluding measurement from the weight sensor at the smart cart;
computing a drift score that represents a change of concluding measurements captured by the weight sensor over time, wherein the computed drift score is based on the concluding measurement and the weight sensor log data;
determining whether the drift score exceeds a threshold value; and
in response to determining that the drift score exceeds the threshold value, recalibrating the weight sensor.

11. The non-transitory computer-readable storage medium of claim 10, the steps further comprising:
filtering the weight sensor log data based on an interquartile range statistical method; and
computing the drift score based on the filtered weight sensor log data.

12. The non-transitory computer-readable storage medium of claim 11, the steps further comprising:
checking each of a set of initial conditions of the smart cart; and
in response to each of the set of conditions meeting a respective threshold, capturing the concluding measurement from the weight sensor at the smart cart.

13. The non-transitory computer-readable storage medium of claim 12, wherein the initial conditions include one or more of stability of the smart cart, motion of the smart cart, and a maximum acceptable drift detected for the weight sensor.

14. The non-transitory computer-readable storage medium of claim 13, wherein the initial conditions include whether the smart cart is empty, the steps further comprising:
receiving image data from one or more cameras at the smart cart; and
determining, based on the image data, that the smart cart is empty.

15. The non-transitory computer-readable storage medium of claim 10, wherein the smart cart includes a set of weight sensors placed at the smart cart.

16. The non-transitory computer-readable storage medium of claim 10, the steps further comprising:
receiving image data from one or more cameras at the smart cart;
determining, based on the image data, that the user did not remove one or more items from the smart cart; and
in response to determining that the user did not remove the one or more items from the smart cart, waiting to capture the concluding measurement until new image data indicates that the one or more items have been removed from the smart cart.

17. The non-transitory computer-readable storage medium of claim 10, the steps further comprising:
comparing the concluding measurement to a most recent previous concluding measurement in the weight sensor log data; and
in response to determining that drift of the weight sensor is not stable based on the comparing, transmitting an indication to service the weight sensor to a client device associated with an operator.

18. The non-transitory computer-readable storage medium of claim 10, the steps further comprising:
comparing the concluding measurement to a most recent previous concluding measurement in the weight sensor log data;
wherein the weight sensor is recalibrated further responsive to determining that drift of the weight sensor is stable.

19. A system comprising:
a processor; and
a non-transitory computer-readable storage medium storing instructions, that when executed, cause the processor to perform steps comprising:
storing weight sensor log data for a smart cart, wherein the weight sensor log data describes a plurality of concluding weight sensor measurements that describe weight sensor measurements captured at ends of user sessions for users at the smart cart;
establishing a user session for a user at the smart cart;
receiving a concluding interaction through a user interface of the smart cart, wherein the concluding interaction is an interaction that indicates a conclusion of the user session with the smart cart; and
in response to receiving the concluding interaction:
displaying a prompt through the user interface for the user to remove items from the smart cart;
capturing a concluding measurement from the weight sensor at the smart cart;
computing a drift score that represents a change of concluding measurements captured by the weight sensor over time, wherein the computed drift score is based on the concluding measurement and the weight sensor log data;
determining whether the drift score exceeds a threshold value; and
in response to determining that the drift score exceeds the threshold value, recalibrating the weight sensor.

20. The system of claim 19, the steps further comprising:
comparing the concluding measurement to a most recent previous concluding measurement in the weight sensor log data;
wherein the weight sensor is recalibrated further responsive to determining that drift of the weight sensor is stable.
